(19) United States
(12) Patent Application Publication
(10) Pub. No.: US 2020/0316901 A1
(43) Pub. Date: Oct. 8, 2020

(54) INFRARED REFLECTIVE MATERIAL

(71) Applicant: STRATA DESIGNS LIMITED, Hinckley, Leicestershire (GB)

(72) Inventor: David BEER, Hinckley (GB)

(73) Assignee: Strata Designs Limited, Hinckley, Leicestershire (GB)

(21) Appl. No.: 16/303,616

(22) PCT Filed: May 18, 2017
(86) PCT No.: PCT/GB2017/051392

§ 371 Date: Nov. 20, 2018

(30) Foreign Application Priority Data
May 24, 2016 (GB) 1609109.2

(51) Int. Cl. B32B 3/30; B32B 7/12; B32B 27/06; B32B 27/18; B32B 38/06; B32B 37/02; G02B 5/20; G02B 1/118

(52) U.S. Cl. CPC B32B 3/30; B32B 2551/00; B32B 27/06; B32B 27/18; B32B 38/06; B32B 37/02; G02B 5/208; G02B 1/118; B32B 2307/416; B32B 2255/10; B32B 2307/41; B32B 2307/42; B32B 2255/26; B32B 2307/418; B32B 7/12

(57) ABSTRACT

A multi-layered infrared reflective material having a layer of an infrared reflective material, and a layer of an infrared transmissive, anti-reflective material, applied directly or indirectly to the infrared reflective material layer, the infrared transmissive, anti-reflective layer being substantially non-reflective to visible light frequencies.

This invention relates to a material that is reflective to infrared light, but substantially non-reflective to other frequencies of electromagnetic waves, and in particular is substantially non-reflective to visible light frequencies.

There are a number of applications in which it is desired to be able to provide an item with a finish that is non-reflective to visible light frequencies, for example to make the presence of the item less obvious by reducing the risk of light reflecting therefrom. Whilst the provision of a non-reflective finish may be desirable in such circumstances, the presence of such a finish has the disadvantage that the item is difficult to view through, for example, infrared enhanced night vision devices or the like as infrared light is not reflected therefrom, or reflections are reduced, thus observing the presence of, and identifying, such an item is difficult.

U.S. Pat. No. 6,701,649 and US2010/259814 both describe arrangements in which objects are provided with infrared reflective regions to aid identification thereof. Whilst the provision of such regions is advantageous in that it aids, for example, identification using infrared enhanced night vision equipment, the regions are generally of relatively high reflectivity to visible light. As a result, they tend not to be unobtrusive as, for example reflection of moonlight or glinting of other light incident thereon draws attention to their presence.

There is a desire, therefore, to provide a material that is non-reflective to visible light, but which is highly reflective to incident infrared light.

According to the invention there is provided multi-layered infrared reflective material comprising a layer of an infrared reflective material, and a layer of an anti-reflective material, applied directly or indirectly to the infrared reflective material layer, the anti-reflective layer being substantially non-reflective to visible light frequencies. The multi-layered infrared reflective material may have a front face upon which light is incident, in use, the material comprising a first layer of an anti-reflective material that is substantially non-reflective to visible light frequencies, the first layer being located substantially at the front face, the anti-reflective material comprising a substrate upon which a plurality of small projections are provided, a second layer that is transmissive to infrared light but absorbent to visible light, the second layer being located at the opposite side of the first layer to the front face, and a third layer of an infrared reflective material, the third layer being located at the opposite side of the second layer to the first layer, wherein visible light incident upon the front face is transmitted through the first layer and is absorbed within the second layer, and infrared light incident upon the front face is transmitted through the first and second layers, and is reflected by the third layer so as to be transmitted back through the second and first layers, in turn.

The anti-reflective material layer is transmissive to infrared light frequencies, thus such frequencies are able to pass through the anti-reflective material layer to be incident upon the infrared reflective material layer.

Such an arrangement is advantageous in that visible light incident on the material is not reflected. As a result, an item incorporating the material upon its outer surface is relatively unobtrusive. However, infrared light incident upon the material is transmitted through the infrared transmissive, anti-reflective layer to the infrared reflective layer, and is reflected back through the infrared transmissive, anti-reflective layer. Accordingly, it will be appreciated that infrared light is reflected from the material, allowing viewing of the item using, for example, infrared enhanced night vision devices.

The anti-reflective material layer conveniently takes the form of a material having a graded refractive index.

As mentioned above, the anti-reflective material layer takes the form of a layer of a material formed with a plurality of small projections. By way of example, the projections may be of generally conical shape. The projections may be arranged in a regular array. However, it is thought that it would be advantageous for the projections to be arranged in an irregular pattern.

Whilst projections of generally conical form are thought to be convenient, other shape projections may be used. By way of example, they may be of part spherical form, or pyramidal form, or of another tapering form, tapering in cross-section substantially continuously.

Each projection is preferably of diameter less than 2 μm. By way of example, the projections may be of diameter in the region of 0.3 to 1.1 μm.

An adhesive material layer may be provided to allow the material to be secured to an item.

Each layer is conveniently of a flexible material, allowing the material as a whole to be flexible and/or to allow it to adopt a desired shape.

It is envisaged that the anti-reflective material layer may be formed by rolling a sheet of a suitable material using a tool having a surface shaped to result in deformation of the sheet to form the projections therein.

The invention will further be described, by way of example, with reference to the accompanying drawings, in which:

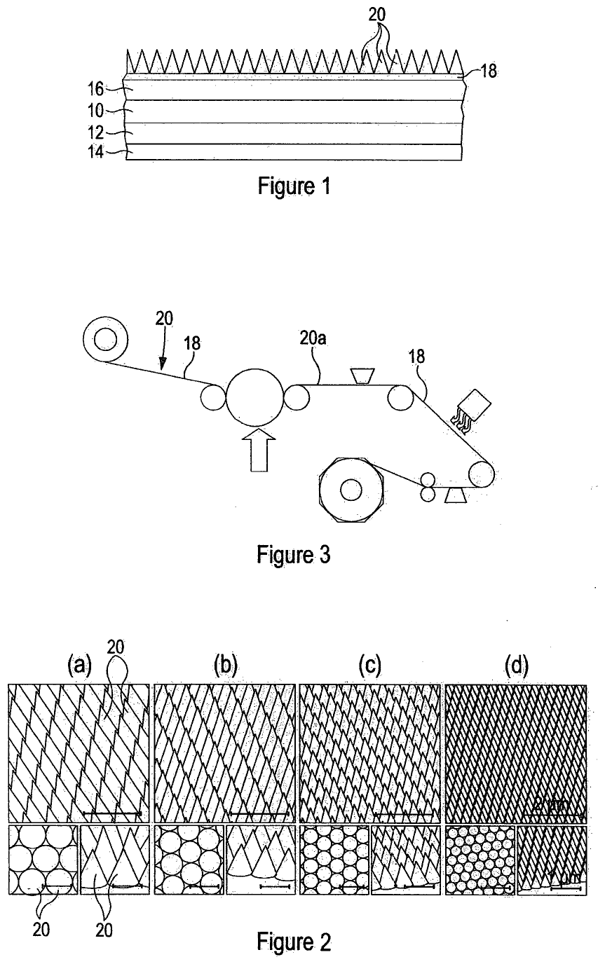

FIG. 1 is a diagrammatic view illustrating a material in accordance with an embodiment of the invention;

FIGS. 2a to 2d are a series of views illustrating the projections of the infrared transmissive, anti-reflective material layer; and

FIG. 3 illustrates a manufacturing method.

Referring to the accompanying drawings, a material having good infrared reflective properties that is substantially non-reflective to visible light frequencies is shown. The material is of multi-layered form, comprising a layer 10 (referred to herein as the third layer 10) that is of a material that is highly reflective to incident infrared light. It may also be highly reflective to other frequencies, but as will be understood from the description below, other light frequencies are not incident thereon, in use, and so whether or not the third layer 10 is reflective thereto is not of particular concern. The third layer 10 has, applied to the rear surface thereof, an adhesive material layer 12 whereby the third layer 10 can be secured to a surface 14 of an item. By way of example, the third layer 10 may take the form of a sheet of a material defining, for example, an array of cube corner micro-prisms or microscopic glass beads that provide a retro-reflective surface that will have the ability to return incident light falling thereon back towards its source. As described below, visible light is prevented from being incident upon the third layer 10, thus only infrared incident light will be reflected from the third layer 10

In the arrangement shown, to the front of the third layer 10 is provided a second layer 16, the second layer 16 being of good infrared transmissive properties but being substantially opaque to incident light in the visible frequencies. Examples of materials having these properties and suitable for use as the second layer 16 are polypropylene/BOPP/PET/PU/PMMA produced as a flexible film and containing suitable light blocking additives, or materials to which a suitable frequency blocking material coating has been applied.

A first layer 18 is provided upon the second layer 16. The first layer 18 is of anti-reflective form, having a graded refractive index. This is achieved, as shown in FIG. 2a, by providing the first layer 18 with a series of very small projections 20. The projections 20, in this embodiment, are each of generally conical form, each having a diameter in the region of 1 μm. The projections 20 are closely packed, so the bases of the projections 20 touch one another or are very closely spaced apart. In the arrangement shown, the projections 20 are arranged in a substantially regular pattern or array, the projections 20 being arranged in a series of rows. However, it is thought that it may be advantageous for the projections 20 to be arranged irregularly, as an irregular arrangement is less likely to result in the formation of an iridescent surface.

The outer surface of the first layer 18 defines a front face of the material upon which light is incident, in use.

The projections 20 are conveniently formed by embossing or deforming the surface of a sheet of material forming the first layer 18, for example by passing the sheet of material between appropriately textured rolls or the like to integrally form the projections 20 on a surface of the sheet. However, this represents just one technique by which the projections 20 may be formed. It is envisaged that the sheet of material will take the form of a suitable flexible polymer material, for example Polypropylene (PP), Biaxially Oriented Polypropylene Films (BOPP), PolyEthylene Terephthalate (PET) or Aliphatic Polyurethane (APU).

As shown in FIG. 3, in an alternative, convenient manufacturing method, the projections 20 are formed on the surface of the first layer 18 by applying a liquid resin 20a to a surface of the layer 18 (which is of ultraviolet transparent form), and passing the layer 18 around a suitably textured roller, textured to form the resin layer 20a into a shape defining the projections 20, with the resin layer 20a facing the textured surface of the roller. Whilst in engagement with the roller, the layer 18 and resin 20a are exposed to ultraviolet light to cure the resin 20a, curing the resin 20a whilst still in contact with the surface of the roller. It will be appreciated that the resin 20a is thus cured in a shape defining the projections 20

As mentioned above, the provision of the series of projections 20 results in the first layer 18 being of graded refractive index, and hence of anti-reflective form. It is transparent at least to infrared frequencies. The second layer 16 is opaque to visible light, serving effectively as a filter, blocking the passage of visible light towards the third layer 10, whilst being transparent to infrared light and so allowing the transmission of infrared light towards the third layer 10. Infrared light incident upon the third layer 10 is reflected back through the second and first layers 16, 18.

Other methods may include moulding the layer 20 in the desired shape.

When exposed to infrared light, therefore, the incident light is transmitted through the first layer 18 and the second layer 16, both of which are transmissive to infrared light, and is incident upon the third layer 10. As the material of the third layer 10 is highly reflective to infrared light, the incident infrared light will be reflected by the third layer 10 back through the second and first layers 16, 18. Visible light is transmitted through the first layer 18 but is absorbed at the second layer 16 which is opaque to visible light. Accordingly, the visible light is not incident upon or reflected by the third layer 10. It will be appreciated that in practise the light incident upon the material will be a mixture of infrared light and other frequencies, and that the material will serve to reflect only the infrared elements or components of the incident light, substantially no visible light being reflected as the surface of the first layer 18, and only the infrared component of the light being reflected by the third layer 10. The presence of the anti-reflective material first layer 18 serves to minimise the reflection of visible light from the front surface of the material.

In use, with the material affixed to an item, it will be appreciated that if viewed remotely using, for example, infrared enhanced night vision equipment, as the material is reflective to infrared light, the user of the equipment will readily be able to see the item with the material affixed thereto, and may be able to use characteristics of the material, for example the shape thereof, to identify the item to which the material is affixed. However, as the material is not reflective to other frequencies, the item to which the material is affixed is relatively unobtrusive.

Each layer of the material is conveniently of flexible form, and the material as a whole is also conveniently of flexible form, allowing the material to be applied to a wide range of items, and allowing the material to be formed to substantially the same shape as the surface of the item to which it is applied. As a result, the presence of the material need not significantly negatively impact upon the manner in which the item is used.

FIGS. 2b to 2d illustrate alternative forms for the projections 20 of the anti-reflective first layer 18. In each case, the projections 20 take the form of substantially conical projections, but the images show the projections as taking a range of sizes. As mentioned above, the projections need not take the form of conical projections, but may be of other shapes, the shapes as sizes being selected so as to ensure that the first layer 18 is of graded refractive index across its thickness and is of good anti-reflective properties.

In an alternative construction, rather than provide a separate, discrete second layer 16 serving to filter out the visible light frequencies whilst allowing infrared frequencies to pass to the third layer 10, this function may be performed by the first layer 18. By way of example, an infrared transparent dye may be incorporated into the material of the first layer 18 so that the first layer 18 provides both an anti-reflective function whilst also only allowing infrared frequencies to pass to the third layer 10, the first layer 18 being opaque to visible light frequencies. This arrangement would have the advantage of removing the need to provide one of the layers, simplifying the structure and the associated manufacturing process, and also reducing the thickness of the material.

Whilst a specific embodiment of the invention is described herein, it will be appreciated that a wide range of modifications and alterations may be made thereto without departing from the scope of the invention as defined by the appended claims.

1. A multi-layered infrared reflective material having a front face upon which light is incident, in use, the material comprising a first layer of an anti-reflective material that is substantially non-reflective to visible light frequencies, the first layer being located substantially at the front face, the anti-reflective material comprising a substrate upon which a plurality of small projections are provided, a second layer that is transmissive to infrared light but absorbent to visible light, the second layer being located at the opposite side of the first layer to the front face, and a third layer of an infrared reflective material, the third layer being located at the opposite side of the second layer to the first layer, wherein visible light incident upon the front face is transmitted through the first layer and is absorbed within the second layer, and infrared light incident upon the front face is transmitted through the first and second layers, and is reflected by the third layer so as to be transmitted back through the second and first layers, in turn.

2. A material according to claim 1, wherein the first, anti-reflective material layer takes the form of a material having a graded refractive index.

3. A material according to claim 1, wherein the projections are of generally conical shape.

4. A material according to claim 1, wherein the projections are of part spherical form, pyramidal form, or are of another tapering form, tapering in cross-section substantially continuously.

5. A material according to claim 1, wherein the projections are arranged in a regular array.

6. A material according to claim 1, wherein the projections are arranged in an irregular pattern.

7. A material according to claim 1, wherein each projection is of diameter less than 2 μm.

8. A material according to claim 7, wherein each projection is of diameter in the region of 0.3 to 1.1 μm.

9. A material according to claim 1, wherein an adhesive material layer is provided to allow the material to be secured to an item.

10. A material according to claim 1, wherein each layer is of a flexible material, allowing the material as a whole to be flexible and/or to allow it to adopt a desired shape.

11. A method of manufacture of a multi-layered infrared reflective material having a front face upon which light is incident, in use, the material comprising a first layer of an anti-reflective material that is substantially non-reflective to visible light frequencies, the first layer being located substantially at the front face, the anti-reflective material comprising a substrate upon which a plurality of small projections are provided, a second layer that is transmissive to infrared light but absorbent to visible light, the second layer being located at the opposite side of the first layer to the front face, and a third layer of an infrared reflective material, the third layer being located at the opposite side of the second layer to the first layer, wherein visible light incident upon the front face is transmitted through the first layer and is absorbed within the second layer, and infrared light incident upon the front face is transmitted through the first and second layers, and is reflected by the third layer so as to be transmitted back through the second and first layers, in turn, wherein the projections are formed by embossing the substrate.

12. A method of manufacture of a multi-layered infrared reflective material having a front face upon which light is incident, in use, the material comprising a first layer of an anti-reflective material that is substantially non-reflective to visible light frequencies, the first layer being located substantially at the front face, the anti-reflective material comprising a substrate upon which a plurality of small projections are provided, a second layer that is transmissive to infrared light but absorbent to visible light, the second layer being located at the opposite side of the first layer to the front face, and a third layer of an infrared reflective material, the third layer being located at the opposite side of the second layer to the first layer, wherein visible light incident upon the front face is transmitted through the first layer and is absorbed within the second layer, and infrared light incident upon the front face is transmitted through the first and second layers, and is reflected by the third layer so as to be transmitted back through the second and first layers, in turn, wherein the projections are formed by applying a liquid resin to the substrate, using a roller to apply a texture to the resin, and curing the resin.

13. A method according to claim 12, wherein the curing is undertaken whilst the roller is in contact with the resin.

14. A method according to claim 13, wherein the substrate is of UV light transparent form, and the curing is undertaken by transmitting UV light through the substrate to the resin.

15. A multi-layered infrared reflective material having a front face upon which light is incident, in use, the material comprising a first layer of an anti-reflective material that is substantially non-reflective to visible light frequencies, the first layer being located substantially at the front face, the anti-reflective material comprising a substrate upon which a plurality of small projections are provided, the first layer being transmissive to infrared light but absorbent to visible light, and a layer of an infrared reflective material, the layer of infrared reflective material being located at the opposite side of the first layer to the front face, wherein visible light incident upon the front face is absorbed within the first layer, and infrared light incident upon the front face is transmitted through the first layer, and is reflected by the layer of infrared reflective material so as to be transmitted back through the first layer.
